(19) United States
(12) Patent Application Publication
(10) Pub. No.: US 2014/0285087 A1
(43) Pub. Date: Sep. 25, 2014

(54) SMART LED CONTROLLER

(71) Applicant: NUVENTIX, INC., Austin, TX (US)

(72) Inventor: Robert T. Reichenbach, Pflugerville, TX (US)

(73) Assignee: NUVENTIX, INC., Austin, TX (US)

(21) Appl. No.: 14/213,926

(22) Filed: Mar. 14, 2014

Related U.S. Application Data
(60) Provisional application No. 61/787,032, filed on Mar. 15, 2013.

(51) Int. Cl. H05B 33/08; F21V 29/00

(52) U.S. Cl. CPC H05B 33/0842; F21V 29/40
USPC 315/112

(57) ABSTRACT

A device (201) is provided which includes a smart LED controller (203), an LED assembly (205) and a synthetic jet ejector (259). The smart LED controller controls the operation of both the LED assembly and the synthetic jet ejector.

### CROSS-REFERENCE TO RELATED APPLICATIONS

This application claims the benefit of U.S. Provisional Application No. 61/787,032, filed Mar. 15, 2013, having the same title, and having the same inventor, and which is incorporated herein by reference in its entirety.

### FIELD OF THE DISCLOSURE

The present disclosure relates generally to synthetic jet ejectors, and more particularly to motors for synthetic jet actuators that are equipped with a means for profiling magnetic flux.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile thermal management solution, especially in applications where thermal management is required at the local level.

Various examples of synthetic jet ejectors are known to the art. Earlier examples are described in U.S. Pat. No. 5,758,823 (Glezer et al.), entitled “Synthetic Jet Actuator and Applications Thereof”; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows”; U.S. Pat. No. 6,056,204 (Glezer et al.), entitled “Synthetic Jet Actuators for Mixing Applications”; U.S. Pat. No. 6,123,145 (Glezer et al.), entitled Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques”.

Further advances have been made in the art of synthetic jet ejectors, both with respect to synthetic jet ejector technology in general and with respect to the applications of this technology. Some examples of these advances are described in U.S. 20100263838 (Mahalingam et al.), entitled “Synthetic Jet Ejector for Augmentation of Pumped Liquid Loop Cooling and Enhancement of Pool and Flow Boiling”; U.S. 20100039012 (Grimm), entitled “Advanced Synjet Cooler Design For LED Light Modules”; U.S. 20100033071 (Heffington et al.), entitled “Thermal management of LED Illumination Devices”; U.S. 20090141065 (Darbin et al.), entitled “Method and Apparatus for Controlling Diaphragm Displacement in Synthetic Jet Actuators”; U.S. 20090109625 (Booth et al.), entitled Light Fixture with Multiple LEDs and Synthetic Jet Thermal Management System“; U.S. 20090084866 (Grimm et al.), entitled Vibration Balanced Synthetic Jet Ejector”; U.S. 20080295997 (Heffington et al.), entitled Synthetic Jet Ejector with Viewing Window and Temporal Aliasing”; U.S. 20080219007 (Heffington et al.), entitled “Thermal Management System for LED Array”; U.S. 20080151541 (Heffington et al.), entitled “Thermal Management System for LED Array”; U.S. 20080043061 (Glezer et al.), entitled “Methods for Reducing the Non-Linear Behavior of Actuators Used for Synthetic Jets”; U.S. 20080009187 (Grimm et al.), entitled “Moldable Housing design for Synthetic Jet Ejector”; U.S. 20080006393 (Grimm), entitled Vibration Isolation System for Synthetic Jet Devices”; U.S. 20070272393 (Reichenbach), entitled “Electronics Package for Synthetic Jet Ejectors”; U.S. 20070141453 (Mahalingam et al.), entitled “Thermal Management of Batteries using Synthetic Jets”; U.S. 20070096118 (Mahalingam et al.), entitled “Synthetic Jet Cooling System for LED Module”; U.S. 20070081027 (Beltran et al.), entitled “Acoustic Resonator for Synthetic Jet Generation for Thermal Management”; U.S. 20070023169 (Mahalingam et al.), entitled “Synthetic Jet Ejector for Augmentation of Pumped Liquid Loop Cooling and Enhancement of Pool and Flow Boiling”; U.S. 20070119573 (Mahalingam et al.), entitled “Synthetic Jet Ejector for the Thermal Management of PCI Cards”; U.S. 20070119575 (Glezer et al.), entitled “Synthetic Jet Heat Pipe Thermal Management System”; U.S. 20070127210 (Mahalingam et al.), entitled “Thermal Management System for Distributed Heat Sources”; U.S. 20070141453 (Mahalingam et al.), entitled “Thermal Management of Batteries using Synthetic Jets”; U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; U.S. Pat. No. 7,607,470 (Glezer et al.), entitled “Synthetic Jet Heat Pipe Thermal Management System”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. Pat. No. 7,784,972 (Heffington et al.), entitled “Thermal Management System for LED Array”; and U.S. Pat. No. 7,819,556 (Heffington et al.), entitled “Thermal Management System for LED Array”.

### BRIEF DESCRIPTION OF THE DRAWINGS

FIGS. 1A-1C are illustrations depicting the manner in which a synthetic jet actuator operates.

FIG. 2 is a diagram of a system for an LED controller in accordance with the teachings herein.

### SUMMARY OF THE DISCLOSURE

In one aspect, a device is provided which comprises (a) an LED assembly; (b) a synthetic jet ejector; and (c) a controller which controls the operation of said LED assembly and said synthetic jet ejector.

### DETAILED DESCRIPTION

Despite the many advances in synthetic jet ejector technology, a need for further advances in this technology still exists. For example, LED lamps are now being used in homes, offices, factories, cars, boats and aircraft to perform countless numbers of lighting tasks with greater efficiency, smaller size, less weight and longer life, then their tungsten and other predecessors. Bright, high-power LEDs frequently require cooling and control. Theatrical, automotive and aircraft applications often require sophisticated control protocols. However, the provision of a first device to control the LED, and a second device to control its thermal management (and in particular, the synthetic jet ejectors used for thermal management), represents a significant complexity and cost in the production of these devices.

It has now been found that the benefits of LED lamps can be further enhanced by the integration of all LED functionality, and related functions such as cooling and remote control, into a single device. Such devices (sometimes referred to herein as “smart LED controllers”), and methods of using them, are disclosed herein.

Prior to further describing the systems and methodologies disclosed herein, a brief overview of synthetic jet actuators may be helpful.

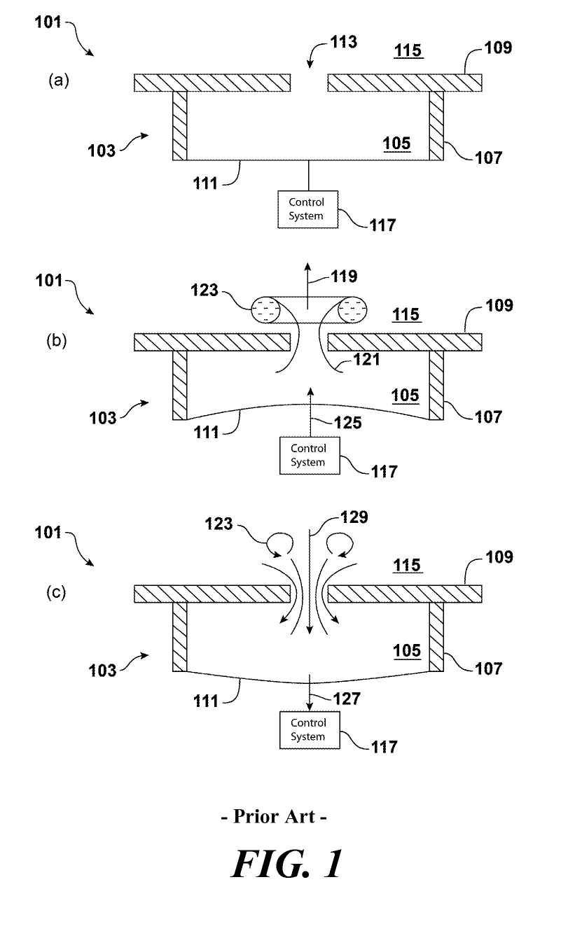

The structure of a synthetic jet ejector may be appreciated with respect to FIG. 1a. The synthetic jet ejector 101 depicted therein comprises a housing 103 which defines and encloses an internal chamber 105. The housing 103 and chamber 105 may take virtually any geometric configuration, but for purposes of discussion and understanding, the housing 103 is shown in cross-section in FIG. 1a to have a rigid side wall 107, a rigid front wall 109, and a rear diaphragm 111 that is flexible to an extent to permit movement of the diaphragm 111 inwardly and outwardly relative to the chamber 105. The front wall 109 has an orifice 113 therein which may be of various geometric shapes. The orifice 113 diametrically opposes the rear diaphragm 111 and fluidically connects the internal chamber 105 to an external environment having ambient fluid 115.

The movement of the flexible diaphragm 111 may be controlled by any suitable control system 117. For example, the diaphragm may be moved by a voice coil actuator. The diaphragm 111 may also be equipped with a metal layer, and a metal electrode may be disposed adjacent to, but spaced from, the metal layer so that the diaphragm 111 can be moved via an electrical bias imposed between the electrode and the metal layer. Moreover, the generation of the electrical bias can be controlled by any suitable device, for example but not limited to, a computer, logic processor, or signal generator. The control system 117 can cause the diaphragm 111 to move periodically or to modulate in time-harmonic motion, thus forcing fluid in and out of the orifice 113.

Alternatively, a piezoelectric actuator could be attached to the diaphragm 111. The control system would, in that case, cause the piezoelectric actuator to vibrate and thereby move the diaphragm 111 in time-harmonic motion. The method of causing the diaphragm 111 to modulate is not particularly limited to any particular means or structure.

The operation of the synthetic jet ejector 101 may be appreciated with respect to FIGS. 1b-FIG. 1c. FIG. 1b depicts the synthetic jet ejector 101 as the diaphragm 111 is controlled to move inward into the chamber 105, as depicted by arrow 125. The chamber 105 has its volume decreased and fluid is ejected through the orifice 113. As the fluid exits the chamber 105 through the orifice 113, the flow separates at the (preferably sharp) edges of the orifice 113 and creates vortex sheets 121. These vortex sheets 121 roll into vortices 123 and begin to move away from the edges of the orifice 109 in the direction indicated by arrow 119.

FIG. 1c depicts the synthetic jet ejector 101 as the diaphragm 111 is controlled to move outward with respect to the chamber 105, as depicted by arrow 127. The chamber 105 has its volume increased and ambient fluid 115 rushes into the chamber 105 as depicted by the set of arrows 129. The diaphragm 111 is controlled by the control system 117 so that, when the diaphragm 111 moves away from the chamber 105, the vortices 123 are already removed from the edges of the orifice 113 and thus are not affected by the ambient fluid 115 being drawn into the chamber 105. Meanwhile, a jet of ambient fluid 115 is synthesized by the vortices 123, thus creating strong entrainment of ambient fluid drawn from large distances away from the orifice 109.

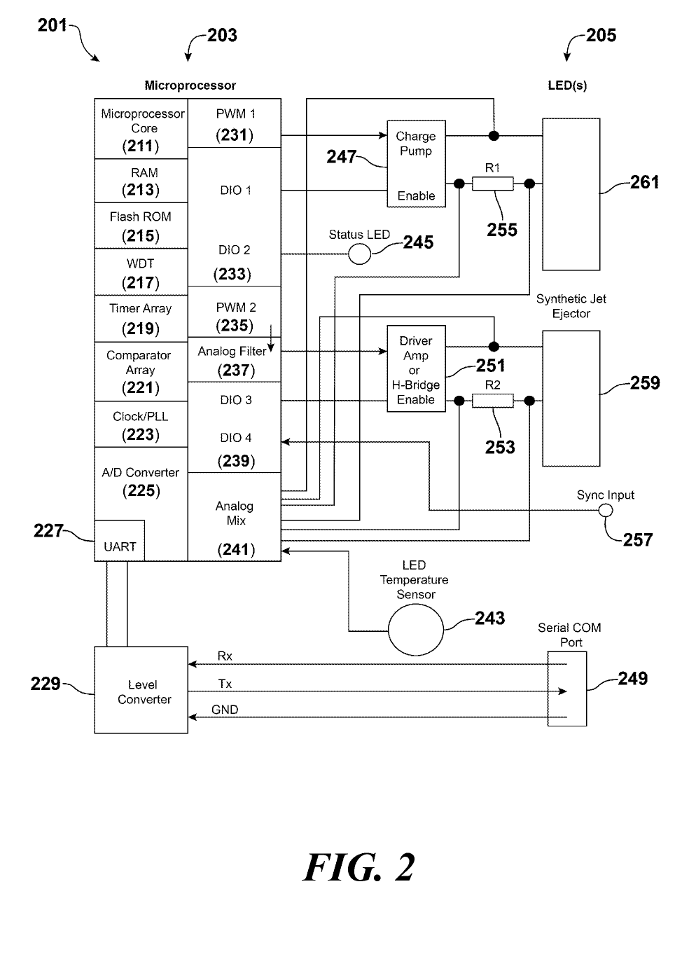

FIG. 2 is a particular, non-limiting embodiment of a system 201 equipped with a smart LED controller in accordance with the teachings herein. As seen therein, the smart LED controller 203 is a controller with all functions integrated into a single electronic circuit, and in which the circuit is preferably microprocessor controlled. As explained in greater detail below, these functions include thermal management of an LED assembly, control of the LED current source, remote control of the device via an interface, and failure detection.

The system 201 of FIG. 2 comprises a microprocessor 203 which controls the current source for one or more LEDs 205. The microprocessor 203 in the particular embodiment depicted comprises one or more microprocessor cores 211, random access memory (RAM) 213, flash read-only memory (ROM) 215, a watchdog timer (WDT) 217 (which may be utilized to detect and recover from malfunctions), a timer array 219, a comparator array 221, a clock/phase-locked loop (PLL) 223 (a control system that generates an output signal whose phase is related to the phase of an input signal), an audio/digital (A/D) converter 225, and a universal asynchronous receiver/transmitter (UART) 227 (this translates between parallel and serial communications). The microprocessor 203 further comprises first 231 and second 235 pulse width phase modulators, first and second diodes (collectively 233), third and fourth diodes (collectively, 239), an analog filter 237, and an analog mixer 241.

The system 201 of FIG. 2 further comprises a level converter 229, a charge pump 247, a status LED 245, a driver amplifier or H-bridge 251, an LED temperature sensor 243, a serial COM port 249 (which allows, for example, remote control of the device), a sync input 257, a synthetic jet ejector 259, and one or more LEDs 261 (which are preferably arranged as an LED array). Notably, the charge pump 247 is in electrical communication with the LEDs 205 by way of a first resistor. Similarly, the driver amplifier or H-bridge 251 is in electrical communication with the synthetic jet ejector 259 by way of a second resistor 253.

In operation, the microprocessor 203 performs thermal management functions by generating, monitoring and adjusting all drive signals for the synthetic jet ejector 259 (which, in some embodiments, may include a plurality of synthetic jet ejectors) as required to maintain proper cooling and control of the LEDs 261. The microprocessor 203 also controls, monitors and adjusts the constant current source required for the LEDs 205 as required to provide the required voltage and current to illuminate the LEDs 205.

This includes PWM-type drive (provided by PWM 1 231 and PWM 2 235) for brightness or dimmer control.

Remote control of the system 201 of FIG. 2 is preferably provided via an industry standard interface such as the PMBus, CAN bus, RS 485 bus, or the like. This control preferably includes such functionalities as ON, OFF, DIMMER, BLINK, BLINK RATE, STROBE, STROBE RATE, COLOR, STATUS, SYNC ON, SYNC OFF, ID, and CONFIG information.

The system 201 of FIG. 2 also provides failure detection, management and reporting. This functionality preferably includes reporting such events as LED failure, LED over high temperature limit, synthetic jet ejector failure (including open actuator, shorted actuator, actuator DCR above high limit), remote interface failure, and problem or failure reporting. Problem or failure reporting may occur by various means including, but not limited to, blinking the LED lamp(s) in a pattern that will attract attention and include a failure code to help determine the cause and remedy of the problem, and sounding beep tones in a pattern that represents the encoded problem code.

The systems and devices disclosed herein offer a number of potential advantages. For example, lower cost may be achieved through the combination of functions into a single device, module or assembly and the use of “Programmable System on a Chip” technology to implement almost all required circuitry into a single I/C which also contains the uP/uC and all required software and firmware. Moreover, size reduction may be achieved by combining all functions into a single device, module or assembly.

In addition, better over-all control of the LED assembly may be achieved through the use a single controller that, in a preferred embodiment, generates, monitors and adjusts (as required) all signals needed to (a) operate the LED drive charge pump constant current source; (b) measure the operating parameters of the LED drive voltage and drive current, and then determine if the charge pump PWM signal needs to be adjusted to maintain the desired LED voltage and current; (c) measure the operating parameters for the synthetic jet ejector and adjust the drive signal frequency; and (d) provide the external sync input that permits synchronization of LED_ON, LED_OFF, and LED_STROBE timing.

The systems, devices and methodologies disclosed herein offer other potential benefits as well. For example, thermal management with synthetic jet technology may provide additional advantages over analogous fan-based thermal management options in terms of reliability, efficiency, and quieter operation. In addition, the use of programmable features or function sets permits field up-grades and related follow-up sales, and proper installation may enables remote control and monitoring via the Internet in applications where this would be beneficial, as in large factories or office complexes.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. A device, comprising:
an LED assembly;
a synthetic jet ejector; and
a controller which controls the operation of said LED assembly and said synthetic jet ejector.

2. The device of claim Al, wherein said controller generates, and monitors and adjusts the drive signals which drive the synthetic jet ejector.

3. The device of claim 1, wherein said controller controls the current source to the LED assembly.

4. The device of claim 1, further comprising a communications port which provides remote control of the device.

5. The device of claim 1, wherein said controller provides failure detection, management and reporting.

6. The device of claim 1, wherein said device includes an LED temperature sensor.

7. The device of claim 1, wherein said device includes a comparator array.

8. The device of claim 1, wherein said device includes a timer array.

9. The device of claim 1, wherein said device includes a watchdog timer.

10. The device of claim 1, wherein said device includes an analog mixer.

11. The device of claim 1, wherein said device includes an analog filter.

12. The device of claim 1, wherein said device includes first and second pulse width modulators.

13. The device of claim 1, wherein said device includes a driver amplifier.

14. The device of claim 1, wherein said device includes an H-bridge.

15. The device of claim 1, wherein said device includes a charge pump which is in electrical communication with said LED assembly by way of a first resistor.

16. The device of claim 1, wherein said device includes an H-bridge which is in electrical communication with said synthetic jet ejector by way of a second resistor.

17. The device of claim 1, wherein said device includes a universal asynchronous receiver/transmitter.
